(19) United States
(12) Patent Application Publication
(10) Pub. No.: US 2013/0160436 A1
(43) Pub. Date: Jun. 27, 2013

(54) ELECTRO-HYDRAULIC TRACTION SUPPORT

(71) Applicant: Continental Automotive Systems, Inc., Auburn Hills, MI (US)

(72) Inventor: Joerg Scheibel, Lake Orion, MI (US)

(73) Assignee: CONTINENTAL AUTOMOTIVE SYSTEMS, INC., Auburn Hills, MI (US)

(21) Appl. No.: 13/707,767

(22) Filed: Dec. 7, 2012

Related U.S. Application Data
(60) Provisional application No. 61/578,573, filed on Dec. 21, 2011.

(51) Int. Cl. B60T 8/48

(52) U.S. Cl. CPC B60T 8/4827
USPC 60/327; 60/414

(57) ABSTRACT

A traction control system comprises a wheel hydraulic motor and pump assembly selectively connectable to a wheel for a vehicle to provide drive to the wheel. An electronic control unit is connected to a main hydraulic control valve to control fluid flow from the main hydraulic motor and pump assembly to the wheel motor and pump assembly. A high pressure accumulator and reservoir are fluidly connected to the main hydraulic motor and pump assembly to provide pressurized fluid to the system.

### PRIORITY

This application is a non-provisional of, and claims priority to the Dec. 21, 2011, filing date of, U.S. provisional patent application Ser. No. 61/578,573, the entire content of which is incorporated herein by reference.

### TECHNICAL FIELD

The present disclosure relates to automotive vehicles, and particularly to and arrangement and method for providing traction support for vehicles.

### BACKGROUND

Providing drive to all four wheels of a vehicle can provide increased control for the driver. Stability control systems can adjust the torque provided to each of the individual wheels to increase stability of the vehicle. However, vehicles currently utilize systems for front and rear traction support that use electric motors, batteries and drive shafts which are heavy and expensive.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A traction control system comprises a wheel hydraulic motor and pump assembly selectively connectable to a wheel for a vehicle to selectively drive the wheel. A main hydraulic control valve is fluidly connected to the wheel actuator and the wheel hydraulic motor and pump assembly. A main hydraulic motor and pump assembly is fluidly connected to the main hydraulic motor and pump assembly. A high pressure accumulator and reservoir are fluidly connected to the main hydraulic motor and pump assembly. An electronic control unit is connected to the main hydraulic control valve to control fluid flow from the main hydraulic motor and pump assembly to the wheel actuator and the wheel motor and pump assembly.

A method of providing traction control for a vehicle comprises actuating a wheel actuator proximate to a wheel for a vehicle to engage a clutch mounted between the wheel and a wheel hydraulic motor and pump assembly. A main hydraulic control valve is controlled to provide pressurized fluid to the wheel actuator and the wheel hydraulic motor and pump assembly. The vehicle wheel is driven with the wheel hydraulic motor and pump assembly while the clutch is engaged.

A traction control system for a vehicle comprises a wheel actuator securable proximate to a wheel for a vehicle. A wheel hydraulic motor and pump assembly is selectively connectable to the wheel for the vehicle. A main hydraulic control valve is fluidly connected to the wheel actuator and the wheel hydraulic motor and pump assembly. A main hydraulic motor and pump assembly is fluidly connected to the main hydraulic motor and pump assembly. A high pressure accumulator and reservoir are fluidly connected to the main hydraulic motor and pump assembly. An electronic control unit is connected to the main hydraulic control valve. The electronic control unit is configured with instructions for: actuating the wheel actuator to engage a clutch mounted between the wheel and the wheel hydraulic motor and pump assembly; controlling the main hydraulic control valve to provide pressurized fluid to the wheel actuator and the wheel hydraulic motor and pump assembly; and driving the wheel with the wheel hydraulic motor and pump assembly while the clutch is engaged.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of a vehicle with a traction control system of the present invention; and

FIG. 2 is a schematic view of the traction control system for the vehicle of FIG. 1.

### DETAILED DISCRIPTION

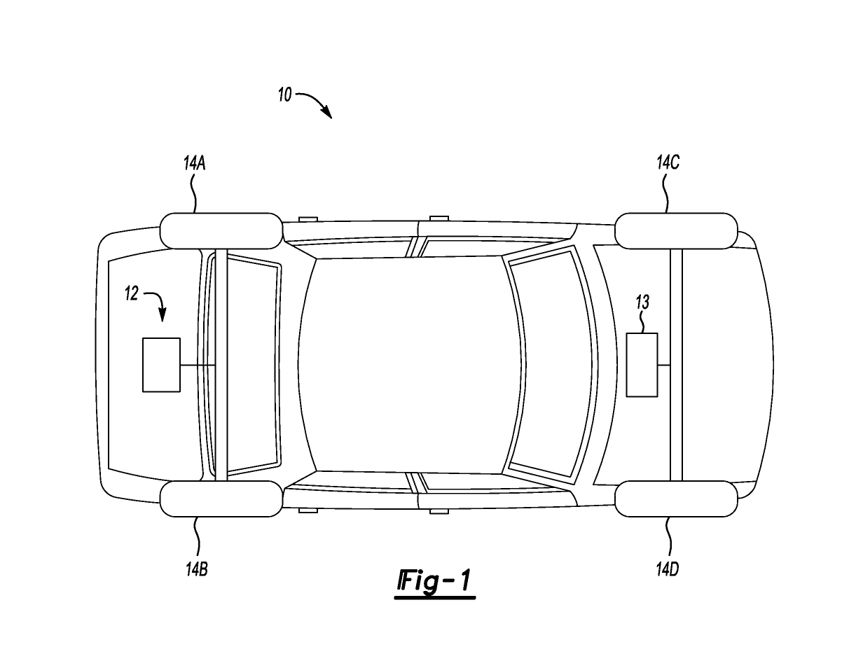

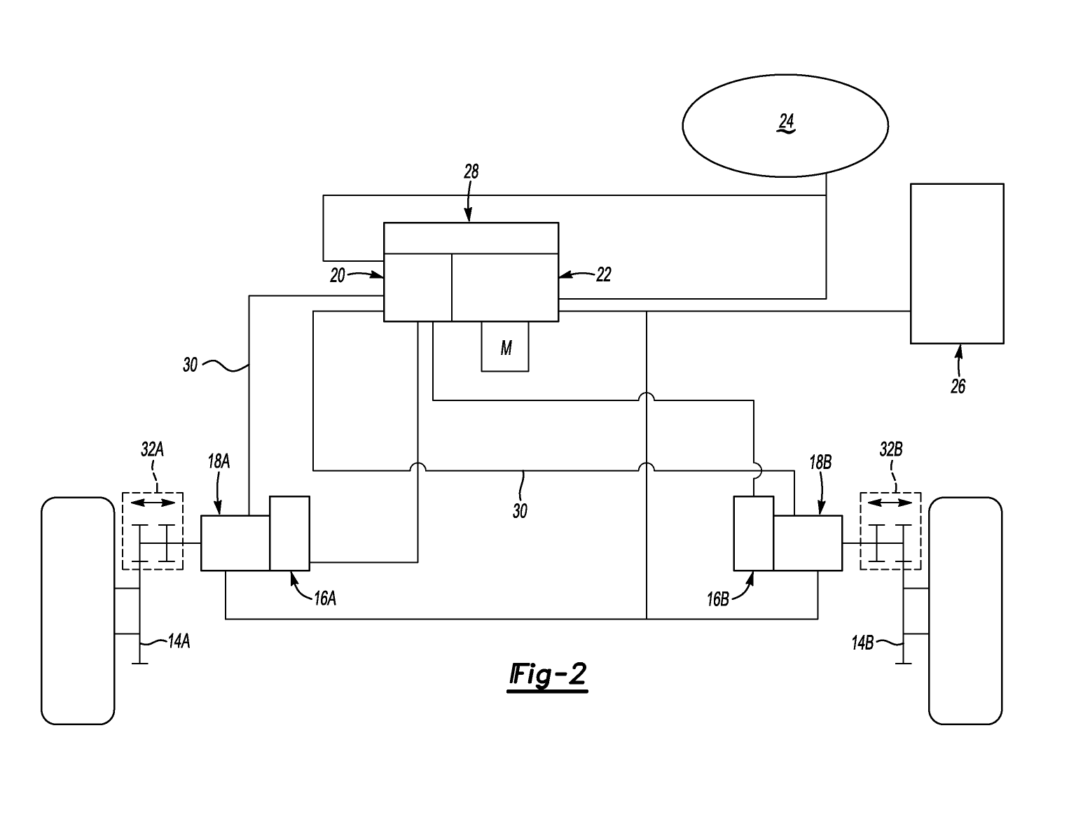

The following description is merely exemplary in nature and is in no way intended to limit the disclosure, its application, or uses. For purposes of clarity, the same reference numbers will be used in the drawings to identify similar elements. FIGS. 1 and 2 illustrate a vehicle 10 of the present invention having a traction control system 12 from providing electro-hydraulic traction support to the vehicle 10. The vehicle 10 is a two wheel drive vehicle. A transmission 13 in connected to two driven wheels 14C, 14D of the vehicle 10. The traction control system 12 is connected to the non-driven wheels 14A, 14B. Here the non-driven wheels 14A, 14B are the rear wheels of the vehicle 10. That is, the non-driven wheels 14A, 14B are not driven by the main power supply of the vehicle 10 for the majority of operating time for the vehicle 10. The traction control system 12 can be used to temporarily provide drive to these wheels 14A, 14B.

The traction control system 12 includes a wheel actuator 16A, 16B and a wheel hydraulic motor and pump assembly 18A, 18B securable to non-driven wheels 16A, 16B for a vehicle 10. The actuators 16A, 16B and the hydraulic motor and pump assemblies 18A, 18B are fluidly connected to a main hydraulic control valve 20, hydraulic motor and pump assembly 22, a high pressure accumulator 24 and a reservoir 26. An electronic control unit 28 is connected to the traction control system 12 to control pressure within the fluid lines 30 connecting the wheel actuators 16A, 16B and the wheel motor and pump assemblies 18A, 18B to the rest of the traction control system 12. A first wheel clutch 32A and a second wheel clutch 32B are used to connect the tractions control system 12 to the wheels 14A and 14B as explained in further detail below.

The traction control system 12 is used to temporarily provide drive to the traditionally non-driven wheels for a two wheel drive vehicle 10. The traction control system 12 can be used to temporarily provide drive for situations such as improved traction in inclement weather, stuck vehicles, etc. Wheel speed sensors 34A, 34B can be used to determine if wheel slip is occurring at either of the wheels 14A, 14B. The wheel slip information is sent to the ECU 28 to control the traction control system 12. When wheel slip is detected the traction control system 12 can be used to provide traction control at the slipping wheel(s) 14A, 14B to provide traction control.

The main hydraulic motor and pump assembly 22 is used to pump fluid from the reservoir 26 and power the high pressure accumulator 24 to increase the fluid pressure of the fluid provided to the main hydraulic control valve 20 and the rest of the traction control system 12. When the traction control system 12 is activated the main hydraulic control valve 20 is opened by the ECU 28 to provide fluid pressure through the fluid lines 30 to the desired wheel(s) 14A, 14B. The ECU 28 instructs the wheel actuator(s) 16A, 16B to engage the clutch 32A, 32B. The clutches 32A, 32B are engaged to connect the wheel(s) 14A, 14B to the main portion of the traction control system 12 for the wheel(s) 14A, 14B that the ECU 28 determines must be driven to improve traction control. Drive is provided to the wheel(s) 14A, 14B as long as the actuator 16A, 16B is activated to engage the clutch 32A, 32B. The wheel actuator 16A, 16B may be either a hydraulic or electrical actuator used to engage the clutch 32A, 32B.

The hydraulic pressure within the fluid lines 30 is used to drive the pump of the wheel motor and pump assembly 18A which in turn drives the motor to generate torque for the wheel(s) 14A, 14B. Return lines 36 are used to send fluid from the wheel motor and pump assembly 18A, 18B back to the reservoir 26. The pressure accumulator 24 may also be charged regeneratively with power from the wheels/brakes 14A-D.

The traction control system 12 may be activated under pre-determined conditions, such as when wheel slip is detected and the vehicle is travelling below a pre-determined speed threshold. Alternatively, the traction control system 12 may be activated by driver command, such as a switch available to the driver.

Unlike the other traction control options the traction control system 12 utilizes hydraulic motors and pumps instead of electric motors for propulsion. The traction control system 12 uses a high pressure accumulator instead of electric batteries which make the traction control system 12 light and low cost. Unlike AWD or 4WD systems, this concept provides only temporary support for improved traction in situations like, inclement weather, inclines, up to a speed range of 15 mph for a limited time, etc. Therefore the traction control system 12 utilizes hydraulics to provide intermittent traction on a non-driven axle without the need for driveshafts and differentials. The traction control system 12 is light weight, low cost, and has high reliability.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A traction control system comprising:
a wheel hydraulic motor and pump assembly selectively connectable to a wheel for a vehicle to selectively drive the wheel;
a main hydraulic control valve fluidly connected to the wheel hydraulic motor and pump assembly;
a main hydraulic motor and pump assembly fluidly connected to the main hydraulic motor and pump assembly;
a high pressure accumulator and reservoir fluidly connected to the main hydraulic motor and pump assembly; and
an electronic control unit connected to the main hydraulic control valve to control fluid flow from the main hydraulic motor and pump assembly to the wheel actuator and the wheel motor and pump assembly.

2. The traction control system of claim 1, further comprising:
a clutch mountable between the wheel hydraulic motor and pump assembly and the wheel of the vehicle to selectively connect the wheel hydraulic motor and pump assembly to the wheel.

3. The traction control system of claim 1, wherein an actuator is connected to actuate the clutch to engage the clutch to connect the wheel hydraulic motor and pump assembly to the wheel of the vehicle.

4. The traction control system of claim 3, wherein the actuator is one of an electric and a hydraulic actuator.

5. The traction control system of claim 1, wherein, the wheel hydraulic motor and pump assembly is two wheel hydraulic motor and pump assemblies each selectively connectable to a respective one of a pair of wheels for the vehicle.

6. The traction control system of claim 5, wherein the wheel actuator is two wheel actuators each securable proximate to the respective one of the pair of wheels for a vehicle and wherein the electronic control unit controls the hydraulic control valve and the two wheel actuators to send fluid to at least one of the pair of wheels.

7. The traction control system of claim 5, wherein the pair of wheels are rear wheels of a vehicle.

8. The traction control system of claim 1, wherein the wheel of the vehicle is not configured to be driven by a transmission for the vehicle.

9. A method of providing traction control for a vehicle comprising:
actuating a wheel actuator proximate to a wheel for a vehicle to engage a clutch mounted between the wheel and a wheel hydraulic motor and pump assembly;
controlling a main hydraulic control valve to provide pressurized fluid to the wheel actuator and the wheel hydraulic motor and pump assembly;
driving the wheel with the wheel hydraulic motor and pump assembly while the clutch is engaged.

10. The method of claim 9, further comprising controlling the main hydraulic control valve with the electronic control unit to control fluid flow from the main hydraulic motor and pump assembly to the wheel actuator and the wheel motor and pump assembly.

11. The method of claim 9, wherein the actuator is one of an electric and a hydraulic actuator.

12. The method of claim 9, wherein the driving the wheel with the wheel hydraulic motor and pump assembly while the clutch is engaged is driving one of a pair of wheels for a vehicle.

13. The method of claim 12, wherein the pair of wheels are rear wheels of a vehicle.

14. The method of claim 9, wherein the wheel of the vehicle is not configured to be driven by a transmission for the vehicle.

15. A traction control system for a vehicle comprising:
a wheel actuator securable proximate to a wheel for a vehicle;
a wheel hydraulic motor and pump assembly selectively connectable to the wheel for the vehicle;
a main hydraulic control valve fluidly connected to the wheel actuator and the wheel hydraulic motor and pump assembly;
a main hydraulic motor and pump assembly fluidly connected to the main hydraulic motor and pump assembly;
a high pressure accumulator and reservoir fluidly connected to the main hydraulic motor and pump assembly; and
an electronic control unit connected to the main hydraulic control valve, wherein the electronic control unit is configured with instructions for:
actuating the wheel actuator to engage a clutch mounted between the wheel and the wheel hydraulic motor and pump assembly;
controlling the main hydraulic control valve to provide pressurized fluid to the wheel actuator and the wheel hydraulic motor and pump assembly; and
driving the wheel with the wheel hydraulic motor and pump assembly while the clutch is engaged.

16. The traction control system of claim 16, wherein the actuator is one of an electric and a hydraulic actuator.

17. The traction control system of claim 16, wherein the pair of wheels are rear wheels of a vehicle.

18. The traction control system of claim 16, wherein the wheel of the vehicle is not configured to be driven by a transmission for the vehicle.
